(19) United States
(12) Patent Application Publication
(10) Pub. No.: US 2003/0099837 A1
(43) Pub. Date: May 29, 2003

(54) Thermoplastic multi-layered film with a layer of vinylcyclohexane-based polymer

(76) Inventors: Dirk Mockel, Krefeld (DE); Miroslav Marek, Prag (CS); Volker Wege, Neuss-Rosellen (DE); Friedrich-Karl Bruder, Krefeld (DE); Konstadinos Douzinas, Koln (DE)

Correspondence Address: BAYER POLYMERS LLC, 100 BAYER ROAD, PITTSBURGH, PA, 15205, US

(21) Appl. No.: 10/168,256

(22) PCT Filed: Dec. 11, 2000
(86) PCT No.: PCT/EP00/12489

(51) Int. Cl. B32B 27/36; B32B 27/00

(52) U.S. Cl. 428/412; 428/423.1; 428/480

(57) ABSTRACT

This invention relates to a multilayer film comprising a layer which contains a vinylcyclohexane-based polymer or mixtures thereof and at least one further layer. The multilayer film is distinguished by elevated water vapour barrier action and low oxygen permeability.

This invention relates to a multilayer film comprising a layer which contains a vinylcyclohexane-based polymer or mixtures thereof and at least one further layer. The multilayer film is distinguished by elevated water vapour barrier action and low oxygen permeability.

A material which is used for packaging articles for daily use, household articles, foodstuffs, various articles, semiconductor devices, pharmaceutical tablets etc. demands various functional properties, such as for example transparency, impermeability to moisture, oxygen barrier properties, heat-sealability, vacuum and pressure formability and manual formability. Such differing requirements are not always adequately met by a single polymer layer, such that multilayer films, which are produced by laminating polymer resin films of differing chemical composition, are widely used. Apart from the use of such laminates for films, there are other applications for such laminates, in particular in the production of bottles, oxygen-absorbent packaging material (EP-A 787 764), containers (for example medical infusion containers JP-A 10 081 795, cold storage pouches for cell cultures, antimicrobial laminated tubular containers JP-A 10 146 924) and the like.

Packaging made from multilayer films is already known. EP-A 450 247 describes multilayer films as packaging material, which for example comprise film layers of polyester, polyethylene and polyvinyl chloride.

EP-A 477 797 describes biaxially oriented, polyolefin multilayer films heat-sealable on both sides comprising a base layer of propylene polymers and outer layers of heat-sealable olefin polymers (ethylene/propylene copolymer) having good optical properties (transparency and gloss). Propylene polymers may, however, only be processed within narrow processing limits due to the partially crystalline nature of the polymer.

EP-A 693 369 described an oriented polyolefin multilayer film comprising a polyolefin base layer and at least one heat-sealable outer layer. The outer layer is made from a heat-sealable polymer comprising aliphatic α-olefins and an amorphous polymer. Atactic polystyrene and atactic polyvinylcyclohexane are listed among numerous amorphous polymers. The multilayer film according to EP-A 693 369 is distinguished by good gloss, low haze, low coefficients of friction and low surface roughness.

Films made from polystyrene or polystyrene copolymers are known prior art. Such films are readily thermoformable. The monomers used are low cost bulk chemicals. However, films made from polymers containing styrene exhibit no particular barrier action towards water vapour and are thus unsuitable for packaging moisture-sensitive goods (H. Klein, “Permeability of polystyrene film”, Kunststoffe (1976), 66(3), 151-156). Complete hydrogenation of polystyrene produces a polyvinylcyclohexane, which, in comparison to polystyrene, exhibits distinctly improved water vapour barrier properties. However, this likewise readily thermoformable film exhibits no particular oxygen barrier properties.

The object of the present invention was to provide a multilayer film having a water vapour barrier layer containing a vinylcyclohexane-based polymer or mixtures thereof and at least one further layer, which film is distinguished by low oxygen permeability and good printability, while retaining properties of relevance to films such as good processability of the polymers used (no formation of fish eyes), thermoformability, adequate mechanical properties and optionally transparency. Depending upon the polymer used for the second or further layers, the multilayer films exhibit good sterilisability.

It has now been found that a multilayer film which contains a layer of a vinylcyclohexane-based polymer or mixtures thereof and at least one further layer exhibits the desired requirements.

The present invention provides multilayer films comprising at least two layers, characterised in that at least one layer contains a vinylcyclohexane-based polymer (A), with the exception of atactic polyvinylcyclohexane, and at least one further layer containing a thermoplastic polymer (B) or a mixture thereof.

The multilayer film preferably consists of 2 to 10, particularly preferably of 2 to 6, in particular of 2, 3, or 4 layers.

Depending upon the application, the thickness of the overall film may vary widely. Thickness is generally 0.01 to 1.5 mm, preferably 0.05 to 1.3 mm and in particular 0.05 to 1 mm.

In the case of use as flexible containers, thickness may also be up to 7 mm, preferably up to 5 mm.

The multilayer film according to the invention may furthermore be provided with one or more layers, for example a paper or metal layer.

Polymer A

Vinylcyclohexane-based polymers are taken to mean homopolymers of vinylcyclohexane as well as copolymers or block copolymers of vinylcyclohexane and other copolymers.

A preferred homo- or copolymer is a vinylcyclohexane-based polymer having the repeat structural unit of the formula (I)

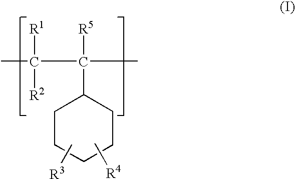

in which

R¹ and R² mutually independently denote hydrogen or C₁-C₆ alkyl, preferably C₁-C₄ alkyl, and

R³ and R⁴ mutually independently denote hydrogen or C₁-C₆ alkyl, preferably C₁-C₄ alkyl, in particular methyl and/or ethyl, or R³ and R⁴ together denote alkylene preferably C₃ or C₄ alkylene (fused 5- or 6-membered cycloaliphatic ring),

R⁵ denotes hydrogen or C₁-C₆ alkyl, preferably C₁-C₄ alkyl,

R¹, R² and R⁵ mutually independently in particular denote hydrogen or methyl.

The following may preferably be used as copolymers during the polymerisation of the starting polymer (optionally substituted polystyrene) and be incorporated into the polymer: olefins generally having 2 to 10 C atoms, such as for example and preferably ethylene, propylene, isoprene, isobutylene, butadiene, very particularly preferably isoprene and/or butadiene, C₁-C₈, preferably C₁-C₄ alkyl esters of acrylic or methacrylic acid, unsaturated cycloaliphatic hydrocarbons, for example cyclopentadiene, cyclohexene, cyclohexadiene, optionally substituted norbornene, dicyclopentadiene, dihydrocyclopentadiene, optionally substituted tetracyclododecene, ring-alkylated styrenes, α-methylstyrene, divinylbenzene, vinyl esters, vinyl acids, vinyl ethers, vinyl acetate, vinyl cyanides, such as for example acrylonitrile, methacrylonitrile, maleic anhydride and mixtures of these monomers. The polymers may generally contain up to 60 wt. %, preferably up to 50 wt. %, particularly preferably up to 40 wt. % of comonomers (relative to the polymer). The polymers may very particularly preferably contain 1 to 30 wt. % of comonomers.

The vinylcyclohexane (co)polymers generally have absolute weight average molecular weights Mw of 1000-10000000, preferably of 60000-1000000, very particularly preferably 70000-600000, determined by light scattering.

The vinylcyclohexane-based polymers may be in both iso- and syndiotactic form. One group of particularly suitable polymers comprises the described vinylcyclohexane-based polymers in syndiotactic form, preferably having a syndiotactic diad content of 50.1 to 74%, in particular of 52 to 70% (c.f. WO 99/32528).

The polymers may both have a linear chain structure and exhibit branch points due to co-units (for example graft copolymers). The branch centres comprise, for example, star-shaped or branched polymers. The polymers according to the invention may also exhibit other geometric shapes of the primary, secondary, tertiary, optionally quaternary polymer structure, possible examples being the helix, double helix, pleated sheet etc. or mixtures of these structures.

Copolymers which may be used are polymers of both random and block structure.

Block copolymers include di-blocks, tri-blocks, multi-blocks and star-shaped block copolymers.

The vinylcyclohexane-based (co)polymers are produced by polymerising styrene derivatives with the appropriate monomers by free-radical, anionic, cationic means or by metal complex initiators or catalysts and then completely or partially hydrogenating the unsaturated aromatic bonds (c.f. for example WO 94/21694, EP-A 322 731).

A block copolymer having at least three blocks, which contains at least one hard block and at least one soft block, is preferably used, wherein the hard block contains at least 50, preferably 60, particularly preferably 65 wt. % of repeat units of the general formula (II),

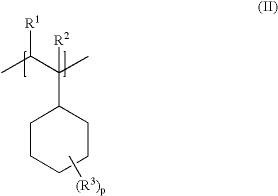

in which

R¹ and R² mutually independently mean hydrogen or C₁-C₆ alkyl, preferably C₁-C₄ alkyl,

R³ denotes hydrogen or C₁-C₆ alkyl, preferably C₁-C₄ alkyl, in particular methyl and/or ethyl, or fused alkylene, preferably C₃ or C₄ alkylene (fused 5- or 6-membered cycloaliphatic ring),

p denotes an integer of 0, 1 to 5, preferably 0, 1 to 3,

and the soft block

contains 100-50 wt. %, preferably 95-70 wt. % of repeat units based on linear or branched C₂-C₁₄ alkylene, preferably C₂-C₈ alkylene and

0-50 wt. %, preferably 5-30 wt. % of repeat units of the general formula (II).

The repeat units in the soft block may be distributed in a random, alternating or gradient manner.

The repeat units according to the formula (II) in the hard and soft block may be either identical or different. A hard block and a soft block may themselves in turn contain various repeat units according to the formula (II).

The hard blocks of the block copolymers usable according to the invention as polymer component A) may contain at most up to 35 wt. % of further repeat units, which are based on usual, optionally substituted olefinic comonomers, preferably C₁-C₄ alkyl-substituted cyclohexadiene, norbornene, dicyclopentadiene, dihydrocyclopentadiene, tetracyclododecene, vinyl esters, vinyl ethers, vinyl acetate, maleic acid derivatives and (meth)acrylic acid derivatives.

The suitable block copolymer may optionally contain further soft blocks prepared from repeat units based on saturated, optionally C₁-C₄ alkyl-substituted, aliphatic hydrocarbon chains with 2 to 10, preferably 2 to 5 carbon atoms and the isomeric forms thereof.

The proportion of hard blocks (relative to the overall polymer) is generally 65 to 97 wt. %, preferably 75 to 95 wt. %, and the proportion of soft blocks 3 to 35 wt. %, preferably 5 to 25 wt. %.

The usable block copolymer generally has (number average) molecular weights of 5000-1000000, preferably of 50000-500000, particularly preferably of 80000-200000 determined by gel permeation chromatography, calibrated with a polystyrene standard. The (number average) molecular weight of the hard blocks is generally 650-970000, preferably from 6500-480000, particularly preferably from 10000-190000. The molecular weight of the soft blocks is generally 150-350000, preferably from 1500-170000, particularly preferably 2400-70000. The block copolymer may contain hard and soft blocks which exhibit differing molecular weights within each type.

The chain units may be linked not only by stereoregular head-tail linkages, but also by a small proportion of head-head linkages. The copolymers may be branched linearly or by means of centres. They may also have a star-shaped structure. Linear block copolymers are preferred for the purposes of this invention.

The block copolymer may exhibit various block structures, wherein the terminal blocks may mutually independently be a hard or a soft block. They may, for example, be of the following structure:

A¹-(Bⁱ-Aⁱ)ₙ;

B¹-(Aⁱ-Bⁱ)ₙ;

(Aⁱ-Bⁱ)ₙ;

wherein

A denotes a hard block, B denotes a soft block,

n denotes ≧1, preferably 1, 2, 3, 4 and

i denotes an integer between 1 and n (1≦i≦n).

The hard and soft blocks in the block copolymer are generally mutually incompatible. This incompatibility leads to phase segregation on the microscopic scale.

The polymer component usable as component A) is preferably produced in a living polymerisation process by reacting vinyl aromatic monomers of the general formula (III) for the hard blocks and conjugated dienes of the general formula (IV) and optionally vinyl aromatic monomers of the general formula (III) for the soft blocks

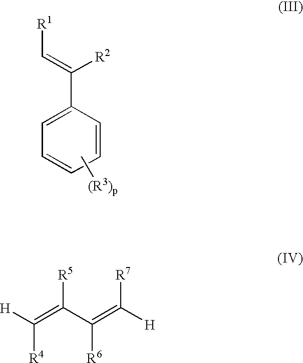

in which

R¹, R², R³ and p have the above-stated meaning and

R⁴ to R⁷ mutually independently mean hydrogen, C₁-C₄ alkyl, preferably methyl,

to yield a prepolymer and then hydrogenating the carbon-carbon double bonds of the prepolymers in the presence of a homogeneous or heterogeneous catalyst.

The monomers according to the formula (III) for the hard and soft block of the prepolymer may be both identical and different. A hard block and a soft block may contain various repeat units based on monomers of the formula (III).

Comonomers which may preferably be used in the polymerisation and incorporated into the hard blocks are: cyclohexadiene, vinylcyclohexane, vinylcyclohexene, norbornene, dicyclopentadiene, dihydrocyclopentadiene, tetracyclododecene, ring-alkylated styrenes, α-methylstyrene, divinylbenzene, vinyl esters, vinyl ethers, vinyl acetate, maleic acid derivatives and (meth)acrylic acid derivatives etc., each optionally substituted by C₁-C₄ alkyl, or a mixture thereof.

The prepolymer may be produced by a living polymerisation process, such as for example living anionic polymerisation or a living free-radical polymerisation. Such polymerisation methods are generally known in polymer chemistry. A living anionic polymerisation process, which may be initiated by alkali metals or by an alkali metal alkyl compound, such as methyllithium and butyllithium, is particularly suitable. Suitable solvents for such a polymerisation are hydrocarbons, such as for example cyclohexane, hexane, pentane, benzene, toluene etc. and ethers, such as for example diethyl ether, methyl tert.-butyl ether, tetrahydrofuran.

Various block structures are obtainable by a living polymerisation process. In the case of anionic polymerisation in a hydrocarbon medium such as cyclohexane or benzene, neither chain termination nor chain transfer occur if active contaminants such as water, oxygen, carbon dioxide etc. are excluded. Block copolymers having defined block segments may be produced by sequential additions of monomer or monomer mixture. A styrene/isoprene or styrene/butadiene di-block copolymer may, for example, be produced by adding the styrene monomers once the diene has completely polymerised. In the present invention, the chain structure is designated by the symbol (I)ₘ-(S)ₙ or (B)ₘ-(S)ₙ or, more simply, by IS or BS respectively. m and n mean the degree of polymerisation of the respective blocks.

It is furthermore known that it is possible to produce block copolymers with a mixed block (“blurred” block boundary) by exploiting favourable cross polymerisation parameters and initiating polymerisation in a monomer mixture. Thus, for example, styrene/butadiene di-block copolymer with a diene-rich mixed block as the soft block may be produced by performing initiation in a mixture of styrene and butadiene in a hydrocarbon medium. The polymer chain contains a diene-rich soft block, a transitional phase having an increasing rate of styrene incorporation and a styrene block which terminates the chain. The chain structure is designated by the symbol (I^{I/S})ₘ-(S)ₙ or (B^{B/S})ₘ-(S)ₙ or, more simply, by I^{IS}S or B^{BS}S, wherein I^{IS} and B^{BS} respectively denote the isoprene-rich and butadiene-rich soft block. The corresponding hydrogenated products are respectively designated H-I^{IS}S and H-B^{BS}S.

By combining the two above-stated methods, it is possible to produce multi-block copolymers having both mixed and defined soft blocks. Examples are tri-block SI^{IS}S, I^{IS}SI and penta-block S(I^{IS}S)₂, (I^{IS}S)₂I. The symbols are self-explanatory. The corresponding hydrogenated products are respectively designated H-SI^{IS}S, H-I^{IS}SI and H-S(I^{IS}S)₂, H-(I^{IS}S)₂I.

Molecular weight may be controlled in anionic polymerisation by varying the monomer/initiator ratio. The theoretical molecular weight may be calculated using the following equation:

$$M = \frac{Total weight of monomers ( g )}{Quantity of initiator ( mol )}$$

Other factors such as solvent, cosolvent, cocatalyst may also have a decisive influence upon chain structure. Hydrocarbons, such as for example cyclohexane, toluene or benzene, are preferred as the polymerisation solvent in the present invention, as block copolymers with a mixed block may be formed in such solvents and the diene monomer preferentially polymerises to yield the highly elastic 1,4-polydiene. A cosolvent containing oxygen or nitrogen, such as for example tetrahydrofuran, dimethoxyethane or N,N,N′,N′-tetramethylethylenediamine brings about random polymerisation and simultaneously a preferential 1,2 polymerisation of conjugated dienes. In contrast, alkali metal alkoxide, such as for example lithium tert.-butylate, while also bringing about random polymerisation, has little influence on the 1,2/1,4 ratio of diene polymerisation. The microstructure of the soft blocks in the prepolymer is crucial to the microstructure of the soft blocks in the corresponding hydrogenated block copolymer. Thus, for example, when hydrogenated, a poly-1,4-butadiene block gives rise to a polyethylene segment, which may crystallise. The hydrogenation product of poly-1,2-butadiene has an excessively high glass transition temperature and is consequently not elastic. Hydrogenating a polybutadiene block with suitable 1,2/1,4 ratios may result in an elastic poly(ethylene-co-butylene) segment. When isoprene is the comonomer for the soft block, 1,4 polymerisation is preferred, as an alternating poly(ethylene/propylene) elastomer block is obtained after hydrogenation.

Temperature, pressure and monomer concentration are largely non-critical to the polymerisation. The preferred temperature, pressure and monomer concentration for polymerisation are in the range −60° C. to 130° C., particularly preferably 20° C. to 100° C., 0.8 to 6 bar and 5 to 30 wt. % (relative to the sum of monomer and solvent quantities).

The process for the production of the block copolymers proceeds optionally with or without, but preferably without, working up to isolate the prepolymer between the polymerisation and hydrogenation stages. Working up, if performed, may proceed by known methods such as precipitation in a non-solvent, such as for example C₁-C₄ alcohol and C₃-C₆ ketone, devolatilising extrusion or stripping etc. . . . In this case, the prepolymer is redissolved in a solvent for the hydrogenation. In the absence of working up, the prepolymer solution may be directly hydrogenated, optionally after chain termination and optionally diluted with the same inert solvent as during polymerisation or with another inert solvent. In this case, a saturated hydrocarbon, such as for example cyclohexane, hexane or mixtures thereof, is preferred as the solvent for the process.

The vinylcyclohexane-based co- or homopolymers are produced by polymerising styrene derivatives with the appropriate monomers by free-radical, anionic, cationic means or by metal complex initiators or catalysts and then completely or partially hydrogenating the unsaturated aromatic bonds (c.f. for example WO 94/21694, EP-A 322 731).

The prepolymers are hydrogenated using generally known methods (for example WO 94/02 720, WO 96/34 895, EP-A-322 731). WO 94/21694 describes a process for the complete hydrogenation of alkenylaromatic polymers and poly(alkenylaromatic)/polydiene block copolymers by heterogeneous catalysis.

Numerous known hydrogenation catalysts may be used as the catalysts. Preferred metal catalysts are stated, for example, in WO 94/21 694 or WO 96/34 896. Any catalyst known for hydrogenation reactions may be used. Suitable catalysts are those with a large surface area (for example 100-600 m²/g) and a small average pore diameter (for example 20-500 Å). Catalysts having a small surface area (for example >10 m²/g) and large average pore diameters, which are characterised in that 98% of the pore volume comprise pores with pore diameters of greater than 600 Å (for example approx. 1000-4000 Å) are furthermore also suitable (c.f. for example U.S. Pat. No. 5,654,253, U.S. Pat. No. 5,612,422, JP-A 03076706). Raney nickel, nickel on silicon dioxide or silicon oxide/aluminium oxide, nickel on carbon as support and/or noble metal catalysts, for example Pt, Ru, Rh, Pd, are in particular used.

Polymer concentrations, relative to the total weight of solvent and polymer are generally 80 to 1, preferably 50 to 10, in particular 40 to 15 wt. %.

Hydrogenation is generally performed at temperatures of between 0 and 500° C., preferably between 20 and 250° C., in particular between 60 and 200° C.

Conventional solvents usable for hydrogenation reactions are described, for example, in DE-AS 1 131 885.

The reaction is generally performed at pressures of 1 bar to 1000 bar, preferably of 20 to 300 bar, in particular of 40 to 200 bar.

The process generally results in virtually complete hydrogenation of the aromatic units and optionally of double bonds located in the main chain. As a rule, the degree of hydrogenation is greater than 97%, particularly preferably greater than 99%. The degree of hydrogenation may, for example, be determined by NMR or UV spectroscopy.

The quantity of catalyst used depends upon the type of process. The process may be performed continuously, semi-continuously or discontinuously.

The ratio of catalyst to prepolymer in the discontinuous process, for example, is generally 0.3-0.001, preferably from 0.2-0.005, particularly preferably from 0.15-0.01.

This invention furthermore relates to a process for the production of the film according to the invention using the per se known extrusion process. Said process is performed here by metering the polymer with a metering device into a conveying screw, heating and melting it and extruding it as a melt through a flat die. The molten film is drawn off through a roll system which orients the film optionally successively or simultaneously in the longitudinal and/or transverse direction with or without heat treatment (in the longitudinal direction by means of fast-running rolls, in the transverse direction using, for example, a tenter frame), is heat-set, corona or flame treated and finally wound onto reels. It has proved advantageous to adjust the temperature of the take-off roll or rolls in accordance with the glass transition temperature of the polymer.

The layer containing the polyvinylcyclohexane-based polymer may contain another polar polymer in addition to the vinylcyclohexane-based polymer. Polar polymers for the purposes of the present invention are preferably selected from the group consisting of polycarbonate, polyacetal, polyamide, polyester, polyurethane, acrylate or methacrylate polymers or mixtures thereof.

The layer preferably contains 0.05 to 8 wt. % of a polar polymer or a mixture thereof, relative to the total quantity of polymer in this layer, 0.1 to 6 wt. % of a polar polymer or a mixture thereof being particularly preferred.

The second and optionally further layers generally contain a polymer or a mixture of polymers selected from at least one of the group of polyolefins, polyamides, polycarbonates, polyurethane and polyesters.

Suitable polyamides are known homopolyamides, copolyamides and mixtures of these polyamides. These may be partially crystalline and/or amorphous polyamides.

Suitable partially crystalline polyamides are polyamide 6, polyamide 6,6, mixtures and corresponding copolymers of these components. Further partially crystalline polyamides which may be considered are those, the acid component of which is selected entirely or in part from at least one acid from the group consisting of terephthalic acid, isophthalic acid, suberic acid, sebacic acid, azelaic acid, adipic acid, cyclohexanedicarboxylic acid, the diamine component of which is selected entirely or in part from among m- and/or p-xylylenediamine, hexamethylenediamine, 2,2,4-trimethylhexamethylenediamine, 2,4,4-trimethylhexamethylenediamine and isophoronediamine and the composition of which is known in principle.

Further polyamides which may be mentioned are those which are produced entirely or in part from lactams having 7 to 12 C atoms in the ring, optionally together with one or more of the above-stated starting components.

Particularly preferred partially crystalline polyamides are polyamide 6 and polyamide 6,6 and the mixtures thereof. Known products may be used as amorphous polyamides. These are obtained by polycondensation of diamines, preferably selected from among ethylenediamine, hexamethylenediamine, decamethylenediamine, 2,2,4- and/or 2,4,4-trimethylhexamethylenediamine, m- and/or p-xylylenediamine, bis(4-aminocyclohexyl)methane, bis(4-aminocyclohexyl)propane, 3,3′-dimethyl-4,4′-diaminodicyclohexylmethane, 3-aminomethyl-3,3,5-trimethylcyclohexylamine, 2,5- and/or 2,6-bis(aminomethyl)norbornane and/or 1,4-diaminomethylcyclohexane or mixtures thereof with dicarboxylic acids, preferably selected from among oxalic acid, adipic acid, azelaic acid, decanedicarboxylic acid, heptadecanedicarboxylic acid, 2,2,4- and/or 2,4,4-trimethyladipic acid, isophthalic acid and terephthalic acid or mixtures thereof.

Copolymers obtained by polycondensation of two or more monomers are also suitable, as are copolymers which are produced with addition of aminocarboxylic acids such as aminocaproic acid, aminoundecanoic acid or aminolauric acid or the lactams thereof.

Particularly suitable amorphous polyamides are the polyamides produced from isophthalic acid, hexamethylenediamine and further diamines such as 4,4′-diaminodicyclohexylmethane, isophoronediamine, 2,2,4- and/or 2,4,4-trimethylhexamethylenediamine, 2,5- and/or 2,6-bis(aminomethyl)norbornene; or from isophthalic acid, 4,4′-diaminodicyclohexylmethane and caprolactam; or from isophthalic acid, 3,3′-dimethyl-4,4′-diaminodicyclohexylmethane and laurolactam; or from terephthalic acid and the isomer mixture of 2,2,4- and/or 2,4,4,-trimethylhexamethylenediamine.

Instead of pure 4,4′-diaminodicyclohexylmethane, it is also possible to use mixtures of the positionally isomeric diaminodicyclohexylmethanes of the following composition

70 to 99 mol % of the 4,4′-diamino isomer

1 to 30 mol % of the 2,4′diamino isomer

0 to 2 mol % of the 2,2′-diamino isomer

optionally corresponding more highly condensed diamines, which are obtained by hydrogenating technical grade diaminodiphenylmethane. Up to 30% of the isophthalic acid may be replaced with terephthalic acid.

Polyamide 6, polyamide 6,6, polyamide 8, 10, 11 and 12 are preferred. Polyamide 6 and polyamide 6,6 are particularly preferred.

The polyamides preferably have a relative viscosity (measured on a 1 wt. % solution in m-cresol at 25° C.) of 2 to 5, particularly preferably of 2.5 to 4.

Preferred polyalkylene terephthalates may be produced from terephthalic acid (or the reactive derivatives thereof) and aliphatic or cycloaliphatic diols having 2 to 10 C atoms using known methods (Kunststoff-Handbuch, volume VIII, pages 695 et seq., Karl-Hanser-Verlag, Munich 1973).

Preferred polyalkylene terephthalates contain at least 80, preferably 90 mol %, relative to the dicarboxylic acid component, of terephthalic acid residues and at least 80, preferably at least 90 mol %, relative to the diol component, of diols selected from the group consisting of ethylene glycol, propylene glycol, 1,4-butanediol, 1,4-cyclohexanedimethanol or mixtures thereof.

Preferred polyalkylene terephthalates may contain, in addition to terephthalic acid esters, up to 20 mol %, preferably up to 10 mol %, of other aromatic dicarboxylic acids having 8 to 14 C atoms or aliphatic dicarboxylic acids having 4 to 12 C atoms, such as residues of phthalic acid, isophthalic acid, 2,6-napthalenedicarboxylic acid, 4,4′-diphenyldicarboxylic acid, succinic, adipic, sebacic acid, azelaic acid, cyclohexanediacetic acid.

Preferred polyalkylene terephthalates may contain, in addition to the above-stated diols, up to 20 mol %, preferably up to 10 mol %, of other aliphatic diols having 3 to 12 C atoms or cycloaliphatic diols having 6 to 21 C atoms, for example and preferably residues of 1,3-propanediol, 2-ethyl-1,3-propanediol, neopentyl glycol, 1,5-pentanediol, 1,6-hexanediol, 3-methyl-2,4-pentanediol, 2-methyl-2,4-pentanediol, 2,2,4-trimethyl-1,3-pentanediol and -1,6, 2-ethyl-1,3-hexanediol, 2,2-diethyl-1,3-propanediol, 2,5-hexanediol, 1,4-di-(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)propane and 2,2-bis(4-hydroxypropoxyphenyl)propane (DE-A 24 07 674, 24 07 776 and 27 15 932).

The polyalkylene terephthalates may be branched by incorporating relatively small quantities of tri- or tetrahydric alcohols or tri- or tetrabasic carboxylic acids, as described, for example, in DE-A 19 00 270 and U.S. Pat. No. 3,692,744. Examples of preferred branching agents are trimesic acid, trimellitic acid, trimethylolethane, trimethylolpropane and pentaerythritol.

It is advisable to use no more than 1 mol % of the branching agent, relative to the acid component.

Particularly preferred polyalkylene terephthalates are those synthesised solely from terephthalic acid and ethylene glycol, propylene glycol or 1,4-butanediol or the copolymers thereof with 1,4-dicyclohexanedimethanol and mixtures of these polyalkylene terephthalates.

The polyalkylene terephthalates generally have an intrinsic viscosity of approx. 0.4 to 1.5 dl/g, preferably of 0.5 to 1.3 dl/g, in each case measured in phenol/o-dichlorobenzene (1:1 parts by weight) at 25° C.

Polyesters are described, for example, in EP-A774490.

Polyolefins for the purposes of the invention are polyethylene, polypropylene, poly-1-butene and polymethylpentene, which may contain small quantities of copolymerised unconjugated dienes. Polyolefins are known and described in Roempp's Chemielexikon and in the literature cited therein. Polypropylene is preferred.

Polycarbonates for the purposes of the invention are those as are described, for example, in EP-A 640 655.

Preferred aromatic polycarbonates are polycarbonates based on 2,2-bis(4-hydroxypheny)propane or one of the diphenols stated as preferred in EP-A 640 655. Those based on 2,2-bis(4-hydroxyphenyl)propane, 2,2-bis(3,5-dimethyl-4-hydroxyphenyl)propane or 1,1-bis(4-hydroxyphenyl)-3,3,5-trimethylcyclohexane or mixtures of 2,2-bis(4-hydroxyphenyl)propane and 1,1-bis(4-hydroxyphenyl-3,3,5-trimethylcyclohexane are very particularly preferred.

Bisphenol A-based polycarbonates are very particularly preferred.

The aromatic polycarbonates generally have average molecular weights M_{w} of approx. 10000 to 200000, preferably of 20000 to 80000 (determined by gel chromatography after prior calibration).

The multilayer films according to the invention may be used in many applications, for example as blister packaging, press-through packages, packaging material.

Blister packaging and press-through packages are used, for example, for pharmaceuticals, household goods, food products, snacks, biscuits, tea bag packaging etc. . . .

The multilayer film according to the invention may be produced using conventional processing techniques known for films, for example by coextrusion, compression moulding, dry lamination, wet lamination, vacuum lamination etc. . . .

Other articles may also be produced from the multilayer film according to the invention, for example flexible containers such as flexible bags, laminate tubes, cups, cartons, composite cans, inner pouches for storage containers for storing products containing flavourings (for example foodstuffs, alcohol-free beverages, cosmetics).

Additives

Additives may be added to the multilayer film according to the invention, which additives are added before or during processing to the polymers or polymer mixtures used for film production. The aim of using such additives is to facilitate processing or to improve the properties of the finished product. Important groups of additives are inter alia antiblocking agents, heat stabilisers or antioxidants, antistatic agents, biostabilisers, colorants, lubricants, light stabilisers, optical brighteners, additives to improve printability.

Suitable antiblocking agents are inorganic additives such as silicon dioxide, calcium carbonate, magnesium silicate, aluminium silicate, calcium phosphate and the like and/or incompatible organic polymers such as polyamides, polyesters, polyurethanes, polycarbonates etc. . . . The effective quantity of antiblocking agent is in the range from 0.1 to 2 wt. %, preferably from 0.1 to 0.5 wt. %. Average particle size is between 1 and 6 μm, in particular 2 and 5 μm, wherein particles of a spherical shape are particularly suitable.

Any usual heat stabilisers may be used as stabilisers. In general, sterically hindered phenols, phosphorus compounds and lactone derivatives may be used either alone or as binary or ternary mixtures. Ternary mixtures are particularly preferred, in particular comprising Irganox 1010 (phenol component), Irgafos P-EPQ (phosphorus compound) and HP 136 (lactone derivative) from the company CIBA Speciality Chemicals, Basel, Switzerland.

Preferred antistatic agents are alkali metal alkanesulfonates, polyether-modified, i.e. ethoxylated and/or propoxylated, polydiorganosiloxanes (polydialkylsiloxanes, polyalkylphenylsiloxanes etc.) and/or the substantially linear and saturated aliphatic, tertiary amines having an aliphatic residue with 10 to 20 carbon atoms, the ω-hydroxy-(C₁-C₄)-alkyl groups being substituted, wherein N,N-bis(2-hydroxyethyl)alkylamines having 10 to 20 carbon atoms, preferably 12 to 18 carbon atoms, in the alkyl group are particularly suitable. The effective quantity of antistatic agent is in the range from 0.05 to 0.3 wt. %.

Colorants which may be considered are dyes and pigments which may be of an inorganic or organic nature. Examples are titanium dioxide, carbon black, oxides and/or mixed oxides of chromium, nickel, iron, azo pigments and phthalocyanines.

Lubricants are hydrocarbons, such as paraffin oils, waxes (for example polyethylene and polypropylene waxes), higher alcohols and carboxylic acids, carboxylic acid esters and amides, glycerides, higher aliphatic acid amides, higher aliphatic acid esters as well as polydimethylsiloxanes. The effective quantity of lubricant is in the range from 0.01 to 4 wt. %, particularly preferably from 0.25 to 1 wt. %.

Light stabilisers are additives which protect films from the effects of light. A distinction is drawn between various classes depending upon their mode of action. In general, hydroperoxide decomposers (metal complexes, organic compounds containing sulfur), quenchers (for example nickel complexes of phenols containing sulfide groups), free radical scavengers (for example sterically hindered amines) and, more rarely, UV absorbers (for example hydroxybenzophenones, hydroxyphenylbenzotriazoles) are used in films. The effective quantity of light stabiliser is between 0.01 and 3 wt. %, particularly preferably between 0.5 and 2 wt. %.

Optical brighteners are additives which offset the yellowish appearance of many plastic films due to the absorption of blue wavelength ranges (blue effect). Examples are triazinephenylcoumarins, benzotriazolepheylcoumarins and bezooxazoles. The effective quantity is between 0.001 and 0.1 wt. %, particularly preferably between 0.01 and 0.05 wt. %.

Low molecular weight resins may be added to bring about further improvement of desired physical properties (for example film stiffness, shrinkage properties, optical properties, water vapour permeability). Compatible hydrocarbon resins are low molecular weight polymers, the (weight average) molecular weight M_{w} of which is generally within a range from 300 to 8000, preferably from 400 to 5000, particularly preferably from 500 to 2000. The resin content is in a range from 1 to 30 wt. %, preferably from 2 to 30 wt. %. Hydrocarbon resins are preferred.

The printability of the outer film may be improved by increasing the polarity of the surface in a suitable manner. This may be achieved by corona treatment or by adding organic or inorganic additives. Organic additives which may be considered are polymers such as polypropylene or polyethylene and homo- or copolymers, polyesters, polyamides, polycarbonate, polyacetals, polyurethanes, acrylate or methacrylate polymers or mixtures thereof. The layer preferably contains 0.05 to 8 wt. %. Suitable inorganic pigments are titanium dioxide, barium sulfate, calcium sulfate or calcium carbonate.

Heat-sealing layers may be applied onto the films according to the invention in order to improve adhesion to films or containers made from thermoplastic polymers. The heat-sealing layers must be tailored to each application. Materials which may be used for heat-sealing layers are, for example, ethylene and propylene polymers having varying contents of polar groups, as are obtainable by copolymerisation with, for example, vinyl acetate, acrylate monomers, or polymers based on copolymers of ethylene or propylene with alpha-olefins and polar monomers. Grafted (for example maleic anhydride-grafted) ethylene and propylene copolymers may also be used as heat-sealing layers. Heat-sealing temperatures may be adjusted by selecting the correct composition.

In some preserving applications for packaged foodstuffs, it is necessary to use oxygen absorbents (for example NaHCO₃, Na₂CO₃ or other carbonates and hydrogen carbonates in conjunction with agents which form or release carbon dioxide.

Multilayer films may also contain oxygen formers (such as peroxides, in particular barium peroxide and calcium peroxides), for example for packaging living fish and shellfish (for example JP 07-289 114, EP-A 905 086).

Multilayer films may be produced using generally known methods by coextruding the polymers used or by separately producing the individual polymer films with a subsequent lamination step.

The multilayer films have many different applications, for example as blister packaging, foodstuff packaging and for packaging electronic articles.

The following Examples are intended to illustrate the invention:

### EXAMPLES

### Example 1

Synthesis of the Polyvinylcyclohexane-based Polymer:

The autoclave is flushed with inert gas (nitrogen). The polymer solution used (see Table 1) is filtered through an SBF-101-S16 filter (from Loeffler Filter-Technik, Nettersheim, Germany) and introduced into the autoclave together with the catalyst (Table 1). Once the autoclave has been sealed, it is pressurised repeatedly with protective gas and then with hydrogen. After depressurisation, the particular hydrogen pressure is established and the reaction mixture heated to the appropriate reaction temperature while being stirred. Once hydrogen absorption has begun, the reaction pressure is held constant. The reaction time is defined as the period starting with heating the batch until the time when hydrogen absorption approaches saturation.

Once hydrogenation is complete, the polymer solution is filtered through a pressure filter equipped with a woven Teflon fabric (B43-MU10, from the company Dr. M. Männendorf, Switzerland). The product solution is then filtered through a 0.2 μm Teflon filter (Pall Filtertechnik, Dreieich, Germany). The polymer solution is stabilised with Irganox XP 420 FF (CIBA Speciality Chemicals, Basel, Switzerland) and refiltered through the stated 0.2 μm filter. The solvent is then removed from the polymer solution at 240° C., the melt filtered through a 20 μm filter and the product pelletised. Neither aromatic nor olefinic carbon-carbon double bonds are detectable by ¹H-NMR spectroscopy.

TABLE 1
Hydrogenation of polystyrene

| | Polymer | | Catalyst | Reaction | Hydrogen | Reaction | Degree of |
|---|---|---|---|---|---|---|---|
| Example | mass¹ | Solvent | mass² | temp. | pressure | time | hydrogenation³ |
| no. | [kg] | [L] | [g] | [° C.] | [bar] | [h] | [%] |
| 1 | 4.8 | 15.1 cyclohexane | 625 | 160 | 100 | 19 | 100 |
| | | 10.1 methyl | | | | | |
| | | t.-butyl ether | | | | | |

¹Polystyrene, grade 158 k, glass-clear, M_{w} = 280000 g/mol, BASF AG, Ludwigshafen, Germany
²Ni/SiO₂/Al₂O₃, Ni-5136 P, Engelhard, De Meern, Netherlands
³Determined by ¹H-NMR spectroscopy

### Example 2

Production of a Two-layer Film by Coextrusion: 1st Layer of Syndiotactic Amorphous Polyvinylcyclohexane (Example 1) 2nd Layer of Polyamide 6

Two-layer A-B films of a total thickness of 200 μm are produced by coextrusion. The base layer B has a thickness of 100 μm and the outer layer A a thickness of 50 μm. The base layer is produced from polyamide 6 (Durethan™ B40, Bayer AG, Leverkusen, Germany) and the outer layer of amorphous syndiotactic polyvinylcyclohexane (c.f. Example 1).

The installation for producing the coextruded film consists of two extruders, a coextrusion adapter, a slot die, a casting roll, a chill roll and a take-off and film winding apparatus. The melt of material A is processed by the following extruder:

| Manufacturer: | Reifenhäuser GmbH, Troisdorf, Germany | |
|---|---|---|
| Screw diameter: | 50 mm | Screw length: 33 D |
| Melt temperature: | 280° C. | |

The melt of material B is processed by the following extruder:

| Manufacturer: | Stork Plastics Machinery B. V., Hengelo, Netherlands | |
|---|---|---|
| Screw diameter: | 45 mm | Screw length: 25 D |
| Melt temperature: | 280° C. | |

The two extruders are independently controlled. The average layer thicknesses are established by supplying the extruders with the material by means of a gravimetric metering system. The melts are brought together in a Reifenhäuser coextrusion adapter and passed through the Reifenhäuser slot die onto the rotating, temperature-controlled casting roll (manufacturer: Reifenhäuser). The already solidified melt is then chilled by the contra-rotating chill roll (manufacturer: Reifenhäuser) and supplied to the film winder by the take-off unit.

### Comparative Example 1

Unoriented Single Layer Polystyrene Film

Polystyrene 158K (BASF, Ludwigshafen, Germany) with a weight average molecular weight M_{w}=260400, a density ρ=1.05 g·cm−3, a glass transition temperature T_{g}=100° C. and a melt index, MFR,=27.4 g/10 min, is extruded at a melt temperature (die) of 250° C. with a Göttfert single screw extruder (screw diameter 30 mm, screw length 25 D) through a flat film die (die width 220 mm, die gap adjustable between 0.01 and 0.6 mm). The temperature of the casting roll is 90° C. A 50 μm thick, clearly transparent film is obtained, which is wound at a take-off speed of 7.3 m/min.

Table 2 shows the gas and water vapour permeabilities of the single layer and multilayer film. A multilayer film structure comprising a polyvinylcyclohexane/polyamide 6 two layer composite film as shown in Example 2 simultaneously increases gas barrier properties and imparts not only an elevated water vapour barrier action but also elevated oxygen barrier properties to the polyvinylcyclohexane-based film system.

TABLE 2
Results

| | | Thick- | | Thick- | | | | H₂O 23° C./ |
|---|---|---|---|---|---|---|---|---|
| | | ness | | ness | O₂¹⁾ | N₂¹⁾ | CO₂¹⁾ | 85% rel. hum. |
| Ex. | Layer A | [μm] | Layer B | [μm] | [cm³ · mm · d⁻¹ · m⁻² · bar⁻¹]²⁾ | | | [g · mm · d⁻¹ · m⁻²] |
| 2 | polyvinylcyclohexane | 90 | polyamide | 200 | 1.5 | 0.3 | 4.6 | 0.20 |
| | | | 6 | | | | | |
| V1⁴ | polystyrene | 50 | — | — | 115³⁾ | 19³⁾ | 533³⁾ | 3.12 |

¹⁾Measurement conditions: pressure, 1000 mbar; gas moisture, dry; T = 25° C., detection by manometric condenser, supplied by MKS
²⁾Numerical values converted to standard conditions (273.15 K)
³⁾from Kunststoffe 66 (1976), H. Klein & H. Vogel, “Permeabilitätsverhalten von Folien aus Polystyrol” [= permeability behaviour of polystyrene films], values from Table 2 for grade P70 at 20° C.
⁴⁾comparison

The following measurement methods were used to characterise the raw materials and films:

Melt Flow Index, MFR

The melt flow index was measured to DIN ISO 1133 using a Meltflixer LT from SWO Polymertechnik GmbH at 280° C. under a weight of 2.16 kg.

Molecular Weight, M_{w}

The weight average molecular weight M_{w}, which is stated in the description of the Examples, states the weight average of the molecular weight. It is determined using two-detector gel permeation chromatography (0.5 wt. % solution, solvent tetrahydrofuran, 25° C., polystyrene standard). Detection proceeds by UV absorption spectroscopy at 254 nm and by differential refractometry of the fractions. Calibration is achieved by means of several polystyrene standards of known molecular weights.

Glass Transition Temperature, T_{g}

Standard injection moulded specimens (flat bars, 80×10×4 mm) of the sample materials were investigated by DMA (dynamic/mechanical analysis). This analysis involves determining the complex modulus of elasticity as a function of temperature at a measurement frequency of 1 Hz. Instrument: RDA-II, Rheometric Scientific Inc., Piscataw, N.J., USA.

Water Vapour Permeability, WVP

The water vapour permeability, WVP, of the sample materials was determined as a function of water vapour permeability. In the case of film samples with a water vapour permeability of >1 g·d⁻¹·m⁻², WVP was determined using the gravimetric method pursuant to DIN 53 122, part 1, while at water vapour permeabilities of <1 g·d⁻¹·m⁻², the determination was performed using the electrolysis method pursuant to DIN 53 122, part 2.

O₂, N₂, CO₂ Gas Permeabilities

Gas permeabilities for O₂, N₂ and CO₂ are determined pursuant to DIN 53 380, part 1, by clamping the film sample in a gas-tight manner in a permeation chamber. The gas to be measured (measurement gas) is introduced at a defined pressure into one part of the chamber and the proportion of the gas permeating into the other, evacuated part of the chamber is recorded by means of a capacitative pressure sensor. Test conditions are: 1000 mbar measurement gas, 23° C. and 0% relative atmospheric humidity.

1. Multilayer films comprising at least two layers, characterised in that at least one layer contains a vinylcyclohexane-based polymer (A), with the exception of atactic polyvinylcyclohexane, and at least one further layer containing a thermoplastic polymer (B) or a mixture thereof.

2. Multilayer film according to claim 1 containing 2 to 10 layers.

3. Multilayer film according to claims 1 or 2 containing 2 to 6 layers.

4. Multilayer film according to any of claims 1 to 3, wherein the thickness of the overall film is up to 7 mm.

5. Multilayer film according to any of claims 1 to 4, wherein the thickness of the overall film is 0.001 to 1.5 mm.

6. Multilayer film according to one or more of the preceding claims, wherein the vinylcyclohexane-based polymer A) is a homopolymer, copolymer or block copolymer.

7. Multilayer film according to one or more of the preceding claims containing as polymer A) a vinylcyclohexane-based polymer having the repeat structural unit of the formula (I) 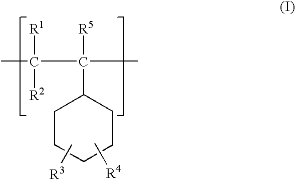
in which
R¹ and R² mutually independently denote hydrogen or C₁-C₆ alkyl and
R³ and R⁴ mutually independently denote hydrogen or C₁-C₆ alkyl, or R³ and R⁴ together denote alkylene,
R⁵ denotes hydrogen or C₁-C₆ alkyl and
wherein comonomers selected from the group consisting of olefins, C₁-C₈ alkyl esters of acrylic or methacrylic acid, unsaturated cycloaliphatic hydrocarbons, substituted tetracyclododecenes, ring-alkylated styrenes, α-methylstyrene, divinylbenzene, vinyl esters, vinyl acids, vinyl ethers, vinyl acetate, vinyl cyanides, maleic anhydride and mixtures of these monomers may be added to the polymerisation and incorporated into the polymer.

8. Multilayer film according to claim 1 containing as polymer A) a block copolymer comprising at least three blocks, which contains at least one hard block and at least one soft block, wherein the hard block contains at least 50 wt. % of repeat units of the general formula (II), 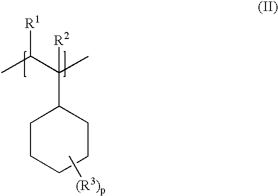
in which
R¹ and R² mutually independently mean hydrogen or C₁-C₆ alkyl,
R³ denotes hydrogen or C₁-C₆ alkyl or fused alkylene,
p denotes an integer of 0, 1 to 5,
and the soft block
contains 100-50 wt. % of repeat units based on linear or branched C₂-C₁₄ alkylene and
0-50 wt. % of repeat units of the general formula (II).

9. Multilayer film according to one or more of the preceding claims containing as polymer B at least one polymer selected from the group of polyamides, polycarbonates, polyolefins, polyurethanes and polyesters.

10. Multilayer film according to one or more of the preceding claims, wherein the layer containing the polymer (A) may contain up to 8 wt. % of a further polar polymer or a mixture thereof.

11. Multilayer film according to one or more the preceding claims, wherein the polar polymers are selected from the group of polyamides, polycarbonates, polyolefins, polyurethanes, polyesters and mixtures thereof.

12. Multilayer film according to one or more of the preceding claims, wherein the layers additionally contain conventional additives.

13. Multilayer film according to claim 12, containing at least one additive selected from the group of antiblocking agents, heat stabilisers or antioxidants, antistatic agents, biostabilisers, colorants, lubricants, light stabilisers, optical brighteners, additives to improve printability.

14. Use of the multilayer film according to any of claims 1 to 13 as packaging material.

15. Packaging material made from a multilayer film according to any of claims 1 to 13.
